(19) United States
(12) Patent Application Publication
(10) Pub. No.: US 2026/0235284 A1
(43) Pub. Date: Aug. 13, 2026

(54) LED LAMP

(71) Applicant: JIAXING SUPER LIGHTING ELECTRIC APPLIANCE CO., LTD, Jiaxing (CN)

(72) Inventors: Dongmei Zhang, Mianyang (CN); Mingbin Wang, Guizhou (CN); Xinyu Wang, Jiaxing (CN); Jianjun Ding, Nanjing (CN); Kun Zeng, Xiangtan (CN); Qili Zhou, Hengyang (CN); Guosheng Tan, Yingtan (CN)

(21) Appl. No.: 19/124,867

(22) PCT Filed: Nov. 7, 2023
(86) PCT No.: PCT/CN2023/130045

§ 371 Date: Apr. 27, 2026

(30) Foreign Application Priority Data
Nov. 9, 2022 (CN) 202211396018.9
Feb. 6, 2023 (CN) 202310131985.0
Mar. 16, 2023 (CN) 202310291350.7
Apr. 20, 2023 (CN) 202310436762.5
Apr. 25, 2023 (CN) 202310467406.X
Sep. 12, 2023 (CN) 202311171744.5
Oct. 31, 2023 (CN) 202311445187.1

(51) Int. Cl. F21V 29/77

(52) U.S. Cl. CPC F21V 29/773

(57) ABSTRACT

An LED lamp (100), compared with existing technologies, LED lamp (100) is lighter and better cooling; comprising a base (1), a light source (2), a heat dissipation (16), a power supply (4), and a hanging support component (9). The base (1) includes a bottom plate (15) and a side wall (14) surrounding the bottom plate (15), the side wall (14) and the bottom plate (15) form an accommodating space, and the light source part (2) is disposed in the accommodating space. The heat dissipation (16) and the power supply (4) are disposed on the base (1), and the projections of the light source (2) and the heat dissipation (16) from the light emitting direction of the LED lamp (100) are spaced apart from the power supply (4) and surround the power supply (4). The hanging support component (9) is fixed to the power supply (4).

### FIELD OF THE INVENTION

The invention relates to lighting technology, particularly to an LED lamp.

### BACKGROUND OF THE INVENTION

LED lamps are widely used in various places due to their easy installation and maintenance, power saving, high brightness and small size. Their core component, the Light-Emitting Diode (LED), is a new generation of solid-state energy with the advantages of long life, high efficiency and energy saving, and green environmental protection.

LED high bay lights in the prior art generally include a lamp body and an LED light source. The main difference between LED high bay lights and household LED lights is that the power of LED high bay lights is much greater than that of household LED lights. The power of the former is usually between 50 W and 200 W, while the power of ordinary household LED lights is generally not more than 20 W. The structures of the two are also very different. High bay lights are usually required to have good heat dissipation and light output performance.

The LED lamps in the prior art generally include a lamp body and an HID light source, and the heat sink of the HID light source is usually formed by aluminum die casting, which can cause the heat sink to be large in size, heavy in weight, and uneven in thickness.

The heat sink is used to quickly dissipate the heat generated by the LED lamp during operation to avoid heat accumulation inside the LED lamp and affect normal operation. However, the heat sink generally increases or occupies the volume of the lamp, which has a certain impact on the packaging and transportation of the lamp.

In the existing design of LED lamps, the light emitting direction can only be fixed at a certain angle. When the environment changes (for example, the installation height or installation angle changes to a certain extent), the original LED lamps cannot or cannot fully meet the current installation environment, and the adaptability of LED lamps cannot meet customer needs.

In summary, in view of the shortcomings and defects of LED lamps in the prior art, how to design LED lamps to improve material utilization and reduce the weight of LED lamps is a technical problem that urgently needs to be solved by technical personnel in this field.

### SUMMARY OF THE INVENTION

This invention provides an LED lamp, which is lighter, has better heat dissipation, is easier to assemble, and has a smaller size than the prior art. Other purposes, effects, and beneficial effects of this invention can be derived from the embodiments.

Many embodiments of the present invention are described in this summary. However, the terms described in present invention are only used to describe certain embodiments disclosed in this specification (whether or not in the claims), rather than a complete description of all possible embodiments. Certain embodiments described here as various features or aspects of the present invention can be combined in different ways to form an LED lamp or a portion thereof.

This invention provides an LED lamp, characterized by comprising: a base, a light source part, a heat dissipation part, a power supply part, and a hanging support assembly. The base includes a bottom plate and a side wall surrounding the bottom plate. The side wall and the bottom plate form an accommodating space, and the light source part is arranged in the accommodating space. The heat dissipation part and the power supply part are arranged on the base, and the projections of the light source part and the heat dissipation part in the light-emitting direction of the LED lamp are spaced apart from the power supply part and surround the power supply part.

In one embodiment of present invention, the light source part includes an LED light-emitting body.

In one embodiment of present invention, the LED lamp further includes a lampshade, and the lampshade covers the LED light-emitting body.

In one embodiment of present invention, the lampshade is made of a light transmitting material.

In one embodiment of present invention, the bottom plate and the side wall are integrally formed.

In one embodiment of present invention, the heat dissipation part includes a plurality of strip-shaped protrusions, and the strip-shaped protrusions are radially distributed.

In one embodiment of present invention, the heat dissipation part includes a plurality of hollow holes.

In one embodiment of present invention, the strip-shaped protrusions have the same radian but different lengths.

In one embodiment of present invention, the lampshade forms a convex lens to diffuse the light emitted by the LED light-emitting body.

In one embodiment of present invention, the light source part and the power supply part are arranged on different sides of the bottom plate.

In one embodiment of present invention, the diameter of the base at the end close to the bottom plate is smaller than the diameter of the base at the end away from the bottom plate.

In one embodiment of present invention, in the base, a first diameter is formed at the end where the side wall is connected to the bottom plate, and a second diameter is formed at the opposite end of the side wall away from the connection with the bottom plate, and the first diameter is less than or equal to the second diameter.

In one embodiment of present invention, the side wall of the base forms a reflective layer through its own material properties or by additionally setting other materials.

In an embodiment of present invention, an LED lamp is provided and characterized by comprising: a base, a light source part, a heat dissipation part, a power supply part, and a hanging support assembly.

The heat dissipation part is distributed along the radial direction of the base and fixed to the base.

The power supply part is located at the center of the base and fixed to the heat dissipation part.

The heat dissipation part is provided with a clamping part for fixing the light source part, and the heat dissipation parts are spaced apart from each other to form a heat dissipation channel that runs vertically.

In one embodiment of present invention, the heat dissipation part is perpendicular to the surface where the light source part is located.

In one embodiment of present invention, the heat dissipation part is parallel to the heat dissipation channel.

In one embodiment of present invention, the projections of the light source part and the heat dissipation part in the light-emitting direction of the LED lamp are spaced apart from the power supply part and surround the power supply part.

In one embodiment of present invention, the power supply part includes a mounting hole recessed in the power supply part.

In one embodiment of the present invention, the hanging support assembly includes a threaded portion, and the threaded portion cooperates with and is fixed to the mounting hole of the power supply part.

In one embodiment of the present invention, the threaded portion includes an extension portion extending radially outwardly along the threaded portion, and the extension portion is provided with at least one limiting through hole.

In one embodiment of the present invention, a limiting hole corresponding to the limiting through hole is provided on the power supply part, and a locking piece is passed through the limiting through hole and screwed with the limiting hole.

In one embodiment of the present invention, the locking piece is perpendicular to the light emitting surface of the LED lamp.

According to the technical solution of the present invention, the base of the LED lamp is formed by stamping a metal plate, which is lighter and has better heat dissipation than a die-cast base. The hollowing of the base and the lampshade can enhance heat dissipation. The strip-shaped protrusions of the base and the lens structure of the lampshade are helpful in adjusting the light output of the LED lamp. The power supply part can be provided with a concave mounting hole, which helps to reduce the height of the lamp.

### BRIEF DESCRIPTION OF DRAWINGS

For purposes of illustration rather than limitation, the present invention will now be described according to its preferred embodiments, particularly with reference to the accompanying drawings, in which:

FIGS. 1A and 1B are exploded views of the main components of an LED lamp according to one embodiment of present invention; Regulations

(canceled)

FIG. 2A is a schematic diagram of a lampshade according to one embodiment of the present invention;

FIG. 2B is a cross-sectional view along the A-A direction in FIG. 2A;

FIG. 2C is an enlarged schematic diagram of point B in FIG. 2B;

FIG. 3 is a schematic diagram of an upward viewing angle of an LED lamp according to an embodiment of the present invention;

FIG. 4 is an overall schematic diagram of an LED lamp at a viewing angle according to one embodiment of the present invention;

FIG. 5 is an overall schematic diagram of an LED lamp from another perspective according to one embodiment of the present invention;

FIG. 6 is a schematic diagram of a power supply part and a hanging support assembly in a combined state according to an embodiment of the present invention;

FIG. 7 is a schematic diagram of a disassembled state of a power supply part and a hanging support assembly according to an embodiment of the present invention;

FIG. 8 is a schematic diagram of a hanging support assembly separated from an LED lamp according to one embodiment of the present invention;

FIG. 9 is a schematic cross-sectional view of the front side of an LED lamp along the radial direction according to one embodiment of the present invention;

FIG. 10 is a schematic cross-sectional view of the back side of an LED lamp along a radial direction according to one embodiment of the present invention;

FIG. 11A is a schematic diagram of the structure of an LED lamp according to an embodiment of the present invention;

FIG. 11B is a schematic diagram of air flow of an LED lamp according to an embodiment of the present invention;

FIG. 12 is an exploded view of the structure of an LED lamp according to an embodiment of the present invention;

FIG. 13A is a schematic diagram of the structure of the base according to an embodiment of the present invention;

FIG. 13B is another schematic diagram of the base according to an embodiment of the present invention;

FIG. 14 is a schematic diagram of the structure of a lampshade according to an embodiment of the present invention;

FIG. 15A is a schematic diagram of the structure of the cover plate according to an embodiment of the present invention;

FIG. 15B is a schematic diagram of a second buckle structure on the cover plate according to an embodiment of the present invention;

FIG. 16 is a schematic diagram of the structure of another lampshade according to an embodiment of the present invention;

FIG. 17 is an enlarged schematic diagram of part A in FIG. 16;

FIG. 18 is a schematic diagram of the structure of a fastener according to an embodiment of the present invention;

FIG. 19A is a schematic diagram of a light pattern according to an embodiment of the present invention;

FIG. 19B is a schematic diagram of a light effect diagram according to an embodiment of the present invention;

FIG. 20A is a schematic diagram of a light pattern according to another embodiment of the present invention; and

FIG. 20B is a schematic diagram of a light effect diagram according to another embodiment of the present invention.

In the figures: 100, LED lamp; 1, base; 11, base screw hole; 12, strip shaped protrusion; 121, hollow slit; 13, mounting hole; 14, side wall; 15, bottom plate; 151, first hollow hole; 152, first card slot; 153, second card slot; 1531, insertion portion; 1532, fastening portion; 16, heat dissipation part; 2, light source part; 20, light board; 21, LED light strip; 201, fastener; 202, first sealing ring; 211, LED light emitting body; 3, lampshade; 31, lampshade screw hole; 32, hollow block; 310, snap-fit cantilever; 320, positioning post; 330, stop portion; 331, first protruding surface; 332, second protruding surface; 301, outermost ring of the lampshade; 302, middle ring of the lampshade; 303, innermost ring of the lampshade; 313, protrusion; 340, annular protrusion; 3401, protruding section; 350, light effect surface; 360, light effect surface; 370, second sealing ring; 4, power supply part; 40, power supply module; 41, limit hole; 410, housing ; 411, adjustment switch; 412, wireless control device; 42, heat dissipation channel; 420, cover plate; 421, clamp; 4211, extension portion; 4212, bending portion; 422, positioning hole; 423, second hollow hole; 5, insulation box; 6, accommodating part; 61, groove ; 62, tongue part; 63, central post; 631, first end of the central post ; 632, second end of the central post; 7, protective ring; 8, light sensor; 9, hanging support component ; 91, threaded portion; 92, suspension portion; 93, locking piece; 94, movable closure; 95, limit through hole.

### DETAILED DESCRIPTION OF THE INVENTION

In order to facilitate the understanding of present invention, present invention will be described in more detail below with reference to the relevant drawings. Preferred embodiments of present invention are shown in the drawings. However, present invention can be implemented in many different forms and is not limited to the embodiments described below. On the contrary, the purpose of providing these embodiments is to make the disclosure of present invention more thoroughly and comprehensively understood. The directions such as “axial direction”, “above”, “below”, etc. in the following text are for the purpose of more clearly indicating the structural position relationship and are not limitations on present invention. In present invention, the “vertical”, “horizontal” and “parallel” are defined as: including situations within ±10% of the standard definition. For example, vertical usually refers to an angle of 90 degrees relative to the reference line, but in present invention, vertical refers to situations within 80 to 100 degrees.

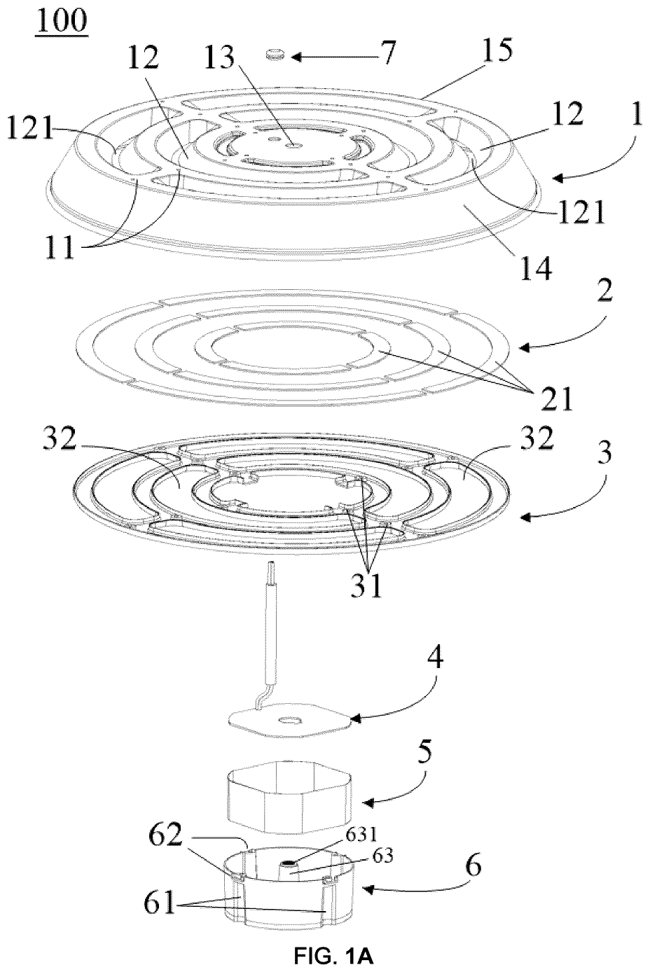

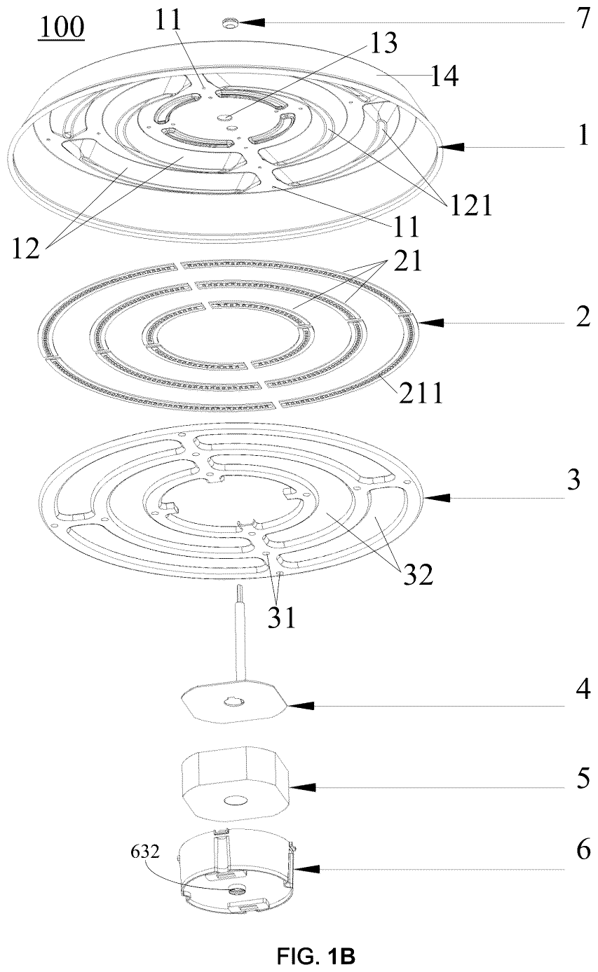

The embodiments of the present invention will be described below in combination with the drawings. FIG. 1A and FIG. 1B are exploded views of the main components of the LED lamp in the embodiment of the present invention. FIG. 1A is a top view, and FIG. 1B is a bottom view. As shown in FIG. 1A and FIG. 1B, the LED lamp 100 in this embodiment of the present invention mainly includes a base 1, a light source part 2, a lampshade 3, a power supply part 4, an insulating box 5, and a receiving portion 6 from top to bottom (based on the view in the figure, the same below). In addition, a protective ring 7 is provided on the base 1.

The light source part 2 is arranged on the base 1. The light source part 2 comprises one or more LED light strips 21. The LED light strips 21 are provided with multiple LED light emitting bodies 211. The LED light emitting bodies 211 can be LED lamp beads or other packaging structures with LED chips. The LED light strips 21 can be annular or substantially annular. The ring formed by multiple LED light strips 21 can be a concentric ring. The ring shape of the LED light strip 21 may include one or more disconnected points, that is, the LED light strip 21 may also be arc-shaped or substantially arc-shaped. Multiple arc-shaped LED light strips 21 may form a ring shape. The disconnected points of the LED light strips 21 on multiple ring shapes may be located at the same radius of the concentric rings, so that the LED light strips 21 on different rings may be electrically connected at the disconnected points.

On the base 1, the LED light strips 21 on different circular rings can have the same radian but different arc lengths. In other words, the lengths of the LED light strips 21 on different circular rings can be different. That is, the length of the LED light strip 21 on the circular ring close to the center of the LED lamp is less than the length of the LED light strip 21 on the circular ring close to the edge of the LED lamp. It can also be said that the length of the LED light strip 21 on the inner circular ring is less than the length of the LED light strip 21 on the outer circular ring. The disconnection design of the LED light strip 21 can reduce the manufacturing cost.

In one embodiment, as shown in the figure, 12 arc-shaped LED light strips are formed into three concentric rings, each of which has four disconnected points.

In a specific embodiment, the base 1 is in a basin shape. The figure shows a case where a circular bottom plate 15 is used, that is, the base 1 includes a bottom plate 15 and a side wall 14 arranged around the bottom plate 15. The side wall 14 surrounds the bottom plate 15 to form an accommodating space, and the light source part 2 is arranged in the accommodating space. The base 1 can be made of a metal plate, such as an aluminum plate, in an integral stamping process. When the LED light strip 21 is directly attached to the base 1, the metal plate can have good heat dissipation performance, and the integrated structure helps to reduce the process and thus reduce the cost. The integrated stamping molding can make the thickness of the base 1 uniform and prevent material waste.

When the LED lamp 100 is assembled, multiple screws are passed through the disconnected points in the above-mentioned concentric rings, and the multiple screws are respectively passed through the multiple base screw holes 11 shown in the figure, and passed through the multiple lampshade screw holes 31 on the lampshade 3, so that the lampshade 3 is connected to the base 1, and the light source part 2 is sandwiched between the two. As shown in the figure, the multiple disconnected points are located on the same straight line, so as to form a radially radiating passage from the center of the bottom plate 15 of the base 1, which is convenient for air convection and improves the heat dissipation effect. In addition, since the disconnected points provides a connection position between the lampshade 3 and the base 1, the disconnected points are located in the same straight line, which is convenient for the design of the lampshade 3 and can improve the aesthetics of the LED lamp 100.

In addition, in other embodiments, the lampshade 3 and the base 1 may not have any screw holes, and the two may be connected by bonding, so that the LED lamp 100 can have better waterproof performance. The bonding position may be at the edge of the lampshade 3. In addition, the disconnected points in the above-mentioned concentric rings may be filled with adhesive/material to achieve the bonding effect.

The bottom plate 15 of the base 1 has a plurality of strip-shaped protrusions 12, specifically, the strip-shaped protrusions 12 are protrusions toward the light emitting direction of the LED lamp. The strip-shaped protrusions 12 increase the heat dissipation area, and the ridge thereof has a hollow slit 121, which further helps the heat dissipation. The LED light strip 21 is located on the side of the strip protrusion 12. Because the base 1 is made of a metal plate and the strip protrusion 12 is protruding toward the lampshade 3, the strip protrusion 12 can reflect the light emitted by the LED light strip 21 obliquely downward, which helps to enhance the light output. Of course, in some embodiments, the strip protrusion 12 can also protrude in the opposite direction of the lampshade 3.

As mentioned above, the multiple LED light strips 21 form two or more concentric rings. The above-mentioned strip-shaped protrusions 12 can be located between the LED light strips 21 in adjacent rings, so that one strip-shaped protrusion can reflect the light emitted by two LED light strips 21. In this embodiment, the multiple LED light strips 21 form three concentric rings, and the multiple strip-shaped protrusions 12 form two concentric rings. In other words, the multiple LED light strips 21 are arranged concentrically with the adjacent strip-shaped protrusions 12, and the LED light strips 21 are arranged parallel to the adjacent strip-shaped protrusions 12 at the same time.

In addition, the strip-shaped protrusions 12 can also be arc-shaped, and multiple strip-shaped protrusions 12 form multiple concentric rings. There are intervals between the strip-shaped protrusions 12 on the same ring, and further have a common center with the concentric rings formed by the LED light strip 21. Such an arrangement not only makes the structure of each component compact, which helps to reduce the volume of the entire lamp, but also makes the strip-shaped protrusions 12 more closely surround the LED light strip 21, thereby having a better light reflection effect on the light emitted by the LED light strip 21. The multiple intervals between the multiple strip-shaped protrusions 12 are also radially distributed from the center of the bottom plate 15, which is beneficial to heat dissipation. At the same time, the LED light strip 21 is also radially distributed from the center (center) of the LED lamp to the periphery (edge) of the LED lamp.

The strip-shaped protrusions 12 on different circular rings may have the same radian, in other words, the number of strip-shaped protrusions 12 on different circular rings may be the same. That is, the lengths of the strip protrusions 12 on different circular rings may be inconsistent, that is, the length of the strip-shaped protrusions 12 on the circular ring close to the center of the LED lamp is shorter than the length of the strip-shaped protrusions 12 on the circular ring close to the edge of the LED lamp. It can also be said that the length of the strip-shaped protrusions 12 on the inner circular ring is shorter than the length of the strip-shaped protrusions 12 on the outer circular ring. Thus, the LED lamp can form multiple convection paths.

In other embodiments, the strip-shaped protrusions 12 on different circular rings can also have different radians. That is, the number of strip-shaped protrusions 12 on different circular rings can be different. In one embodiment, the number of strip-shaped protrusions 12 on the inner circular ring is less than the number of strip-shaped protrusions 12 on the outer circular ring. Thus, while ensuring the strength of the base 1, the number of strip-shaped protrusions 12 on the base 1 is reduced, and then the reflection area of the strip-shaped protrusions 12 on the LED light strip is increased.

In this embodiment, the inner ring includes two strip-shaped protrusions 12, and the outer ring includes four strip-shaped protrusions 12.

In addition, the length relationship between each strip-shaped protrusion 12 and the LED light strip 21 can be flexibly set. For example, for the concentric rings formed by multiple strip-shaped protrusions 12 and multiple LED light strips 21, the length of the outermost ring of the LED light strip 21 can be greater than the length of the outermost ring of the strip-shaped protrusion 12, the length of the innermost ring of the strip-shaped protrusion 12 can be greater than the length of the outermost ring, or the length of the innermost ring of the strip-shaped protrusion 12 can be greater than the length of the innermost ring of the LED light strip 21.

The height of each strip-shaped protrusion 12 is preferably within a suitable range. If it is too high, it will affect the light output of the LED light strip 21, and if it is too low, it will affect the heat dissipation and reflective effect. The ratio of the height of each strip-shaped protrusion 12 to the vertical height of the side wall 14 of the base 1 (or it can be understood as the overall thickness of the base 1) is 0.1~0.4; preferably, the ratio of the height of each strip-shaped protrusion 12 to the height of the side wall 14 of the base 1 is 0.15~0.35; more preferably, the ratio of the height of each strip-shaped protrusion 12 to the height of the side wall 14 of the base 1 is 0.2~0.3. In other words, the bottom plate 15 of the base 1 includes at least two surfaces at different heights.

The power supply part 4 is disposed in the insulating box 5, and the two are placed together in the receiving portion 6. In other words, the receiving portion 6 has a receiving space, and the insulating box 5 and the power supply part 4 are disposed therein. The insulating box 5 can be made of Mylar sheet. The receiving portion 6 can be connected to the base 1 by snapping or threading. The height of the receiving portion 6 (or the overall thickness of the receiving portion 6) mainly depends on the size of the contents (electronic components or electronic elements) of the power supply part 4, and should not be too large. In this embodiment, the height of the receiving portion 6 is not greater than the height of the side wall 14 of the base 1 (or can be understood as the overall thickness of the base 1), so as to prevent the power supply part 4 from being exposed from the base 1. The height ratio of the receiving portion 6 to the base 1 can be selected as 0.5-1; preferably, the height ratio of the receiving portion 6 to the base 1 can be selected as 0.6-1. More preferably, the height ratio of the receiving portion 6 to the base 1 can be selected as 0.75-1. Because the receiving portion 6 is located inside the base 1, the height of the entire lamp is reduced compared to the form in which the power supply part is arranged outside the base.

The receiving portion 6 can be made of a reflective material, or coated with a reflective coating such as white paint, or covered with a reflective layer, etc. Thus, the light emitted toward the receiving portion 6 can be reflected by the surface of the receiving portion 6, changing the light emission angle and reducing the central dark area of the LED lamp.

The ratio of the area of the cross section of the receiving portion 6 parallel to the bottom plate 15 to the area of the bottom plate 15 of the base 1 may be 0.035-0.15; preferably, the ratio of the area of the cross section of the receiving portion 6 parallel to the bottom plate 15 to the area of the bottom plate 15 of the base 1 may be 0.035-0.1; more preferably, the ratio of the area of the cross section of the receiving portion 6 parallel to the bottom plate 15 to the area of the bottom plate 15 of the base 1 may be 0.035-0.07. The use of this numerical range for the receiving portion 6 helps to avoid the formation of an obvious central dark area in the light output range. If the area occupied by the cross section of the receiving portion 6 is too large, it is easy to cause the above-mentioned central dark area. In addition, the side and/or bottom surface of the receiving portion 6 may be provided with an LED light emitter to reduce the central dark area.

Referring to FIG. 1A, the outer wall of the receiving portion 6 is provided with a plurality of grooves 61, and the upper edge corresponding to the grooves 61 is provided with a plurality of tongue part 62 having a width close to that of the grooves 61 and extending away from the outer wall. The receiving portion 6 can be connected and fixed to the base 1 through the tongue part 62. Specifically, the tongue part 62 can include a connection hole, and a fixing member such as a screw can pass through the hole of the tongue part 62 to connect and fix the receiving portion 6 to the base 1. In other embodiments, the tongue part 62 can also be connected and fixed to the receiving portion 6 and the base 1 by other means such as glue.

Referring to FIG. 1A, a central column 63 perpendicular to the bottom of the receiving portion 6 is provided at the center of the receiving portion 6. The power box 4 can be connected and fixed to the mounting component through the central column 63, such as the mounting hole 13 on the bottom plate 15, so that the power box 4 can be assembled and fixed to the base 1. Specifically, the central column 63 has an internal thread, and the central column 63 can be connected and fixed to the mounting component through the internal thread. Further, the central column 63 may include a first end 631 connected and fixed to the mounting component. The central column 63 may also include a second end 632. Referring to FIG. 1B, the second end 632 is located at the bottom of the receiving portion 6, and can be used to connect components such as sensors. The center of the bottom plate 15 has a mounting hole 13, and the mounting hole 13 has an internal thread, so that a screw can pass through and reach the first end 631 of the center column near the bottom plate 15. The screw can be provided with a hanging ring or a hanging hook. Mounting holes can also be provided at other parts of the bottom plate 15 to connect the mounting frame. The above-mentioned hanging ring, hanging hook, or mounting frame is used to fix the entire lamp to the roof, wall or other supporting objects. Referring to FIG. 1B, the second end 632 of the center column is located at the bottom of the receiving portion 6, and can be used to connect components such as sensors. As shown in FIG. 3, FIG. 3 is a schematic diagram of the appearance of the LED lamp according to the embodiment of the present application. FIG. 3 shows an upward angle, wherein the bottom center of the receiving portion 6 is connected to the sensor 8.

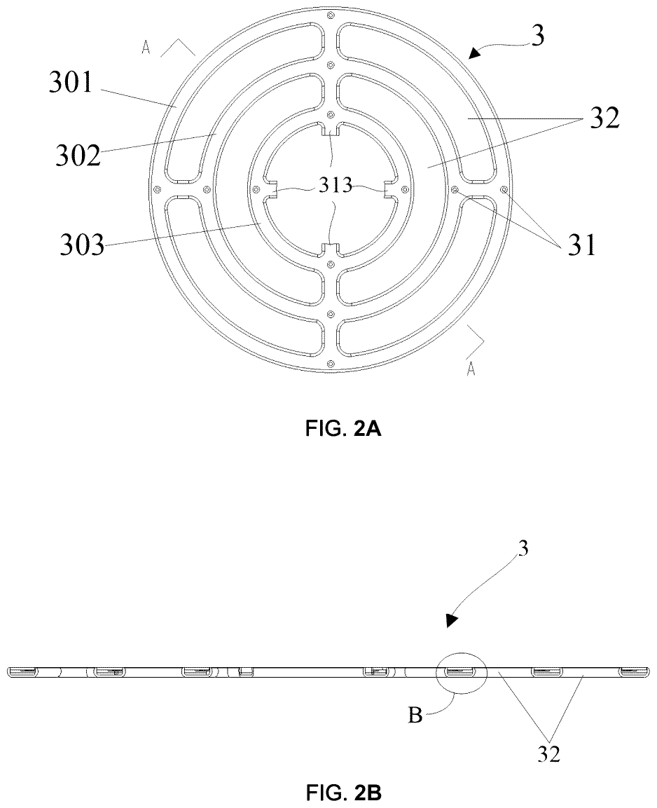

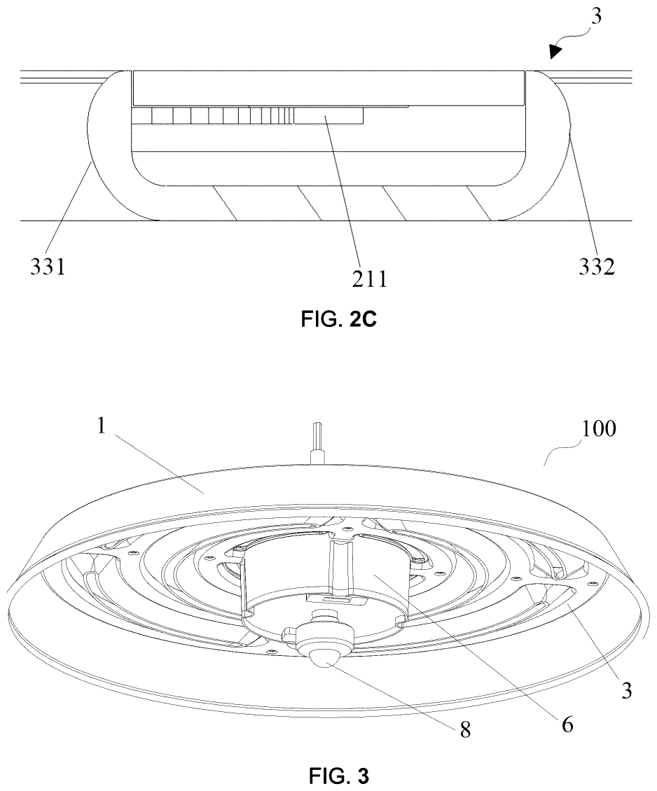

The main function of the lampshade 3 in this embodiment is to clamp the light source 2, that is, to cover the LED light emitting bodies 211 of the light source 2, that is, to completely cover the LED light emitting bodies 211. Therefore, in order to improve heat dissipation, a plurality of hollow blocks 32 are formed on the portion of the lampshade 3 that is not in contact with the light source 2, and materials can also be saved. Because the lampshade 3 is made of a light-transmitting material, such as glass, resin, acrylic, plastic, etc., in one embodiment of the present application, it can be a transparent material, so in this embodiment, the lower surface of the lampshade 3 is made into a protrusion to form a lens. As shown in FIG. 2A, FIG. 2B and FIG. 2C, FIG. 2A is a schematic diagram of the lampshade in the embodiment of the present application, FIG. 2B is a cross-sectional view taken along the line A-A of FIG. 2A, and FIG. 2C is an enlarged schematic diagram of the position B of FIG. 2B. As can be seen from FIG. 2B and FIG. 2C, the lampshade 3 has a first protruding surface 331 and a second protruding surface 332 to form a convex lens, and the light emitted by the LED light emitting bodies 211 will be refracted by the convex lens and diverge to both sides, i.e., a light diffusion effect. By selecting the curvature of the first protruding surface 331 and the second protruding surface 332, various light output angles of the entire lamp can be achieved, such as 120°, 90°, 60°, etc.

Referring to FIG. 2A, the portion where the lampshade 3 contacts the light source unit 2 is also in the shape of concentric circles, and the lampshade 3 may include one or more circles. The number of circles of the lampshade 3 may be the same as the total number of the light source parts 2, so that each circle of the lampshade 3 is respectively covered on each circle of the light source parts 2. In the present embodiment, the lampshade 3 includes 3 circles. The figure shows the outermost ring 301, the middle ring 302, and the innermost ring 303 of the lampshade 3. The innermost circle 303 of the lampshade is circumferentially provided with a plurality of protrusions 313 extending toward the center of the circle. The protrusions 313 allow electrical structures such as wires to pass through, so that the light source part 2 can be electrically connected to the power supply part 4. The positions of the plurality of protrusions 313 and the tongue parts 62 of the plurality of receiving portions 6 correspond to each other, so that when the receiving portion 6 penetrates the lampshade 3 from top to bottom according to the viewing angle of FIG. 1A or FIG. 1B, each protrusion 313 passes through each groove 61 and contacts the plurality of tongue parts 62. In this way, the plurality of tongue parts 62 are sandwiched between each protrusion 313 and the bottom plate 15, thereby conveniently and reliably fixing the receiving portion 6. Moreover, electrical structures such as wires can enter the power supply part 4 through the connection between the protrusion 313 and the tongue part 62.

The implementation of the LED lamp of the present application in each embodiment is as described above. It should be noted that in each embodiment, for the same LED lamp, the features including “the light source part is mainly one or more LED light strips”, “the LED light strip is provided with multiple LED light emitters”, “the LED light strip can be annular or substantially annular”, “the ring formed by multiple LED light strips can be concentric rings”, “the ring of the LED light strip can include one or more disconnections”, “the LED light strip can also be arc-shaped or substantially arc-shaped”, etc., can be applied only individually or in an integrated manner in practice, so that only one feature is implemented or several features are implemented at the same time.

For example, the light source part is mainly one or more LED light strips, and a plurality of LED illuminants are arranged on the LED light strips.

For example, the LED light strip can be in a circular or approximately circular shape.

In the above embodiment, the plurality of strip-shaped protrusions 12 can also be referred to as the heat dissipation part of the LED lamp. The strip-shaped protrusions 12 (heat dissipation part) are arranged on the periphery of the power supply part 4, that is, in the light emitting direction of the LED lamp, the projections of the strip-shaped protrusions 12 (heat dissipation part) and the power supply part 4 do not overlap with each other, or the overlapping area is zero, and the strip-shaped protrusions 12 (heat dissipation part) surround the power supply part 4, but do not directly contact each other, that is, they are spaced from each other. Similarly, the positional relationship between the light source part 2 (or the luminous body 21) and the power supply part 4 is the same as the positional relationship between the strip-shaped protrusions 12 (heat dissipation part) and the power supply part 4.

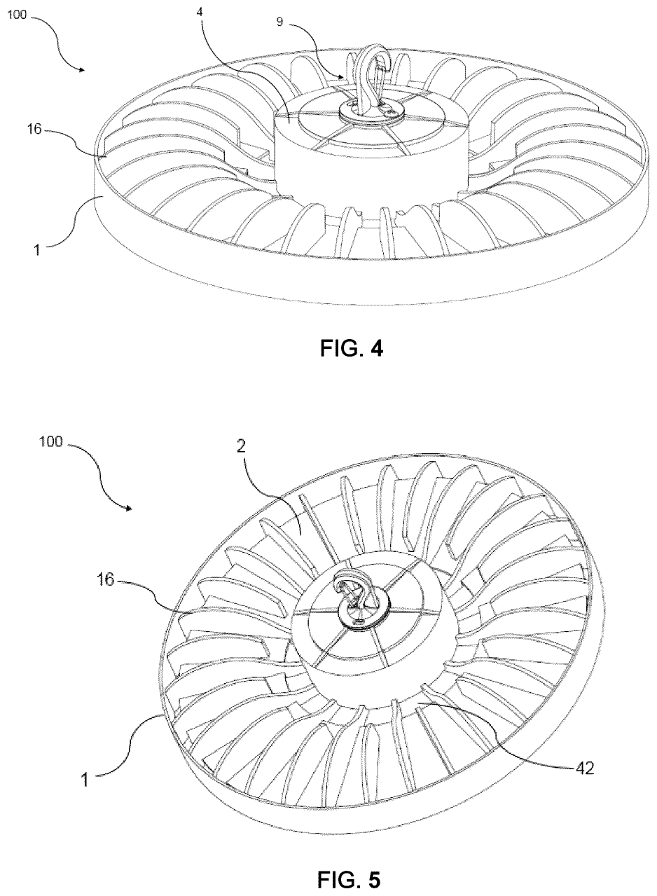

Refer to FIGS. 4 and 5, which are overall schematic diagrams of different viewing angles of an LED lamp in another embodiment of the present application. As shown in the figure, the LED lamp 100 includes a base 1, and the outer contour of the base 1 along the light emitting direction is in the shape of a circular ring. A plurality of heat dissipation parts 16 are arranged along the circular ring structure pointing to the inside of the circular ring, that is, the base 1 includes at least one heat dissipation part 16, and the heat dissipation part 16 can be a heat dissipation fin along the optical axis direction of the LED lamp. The heat dissipation part 16 is along the circular ring where the outer contour of the base 1 is located, and is evenly distributed along the radial direction of the circular ring. The heat dissipation part 16 points to the center of the circular ring where the base 1 is located, and one end of at least one heat dissipation part 16 is in contact with and fixed to the power supply part 4 located at the center of the circular ring of the base 1, and the other end is fixed to the outer contour of the base 1, thereby achieving the fixation of the power supply part 4.

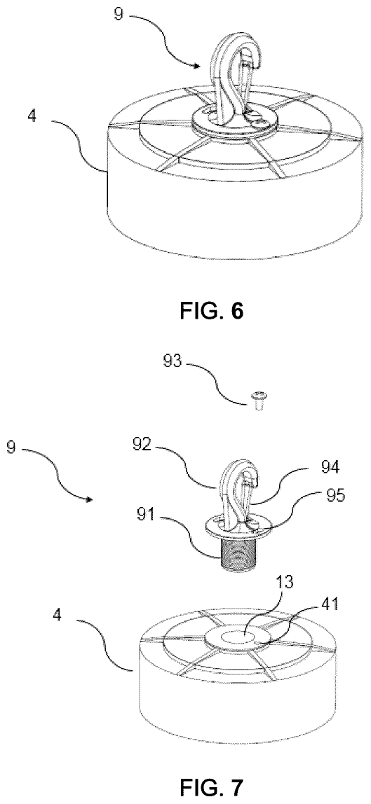

Referring to FIG. 6 and FIG. 7, FIG. 6 is a schematic diagram of a power supply part 4 and a hanging support component 9 in a combined state in an embodiment of the present application, and FIG. 7 is a schematic diagram of a power supply part 4 and a hanging support component 9 in a disassembled state in an embodiment of the present application, wherein the power supply part 4 is cylindrical, and its circumferential surface is at least partially in contact with the heat dissipation unit 16, and a hanging support component 9 is disposed on one surface thereof, and a threaded portion 91 is disposed at one end of the hanging support component 9, and a hanging portion 93 and a movable closure 94 cooperating with the hanging portion 93 are disposed at the other end. The hanging support component 9 is matched with the mounting hole 13 on the power supply part 4 through the threaded portion 91 to achieve connection and fixation, and is fixed to the installation place through the hanging portion 93 and the movable closure 94, and the power supply part 4 is fixed to the heat dissipation part 16 (that is, the base 1), so that the LED lamp 100 can be fixed to the installation place. Among them, the movable closure 94 can be opened and closed relative to the hanging portion 93 to form a completely closed ring structure or a semi-closed ring structure, thereby achieving the fixing and removal of the LED lamp to the installation place.

The hanging support component 9 has an end face with a diameter larger than that of the threaded portion 91 at one end of the threaded portion 91, and the end face extends radially outward for a certain distance along the threaded portion 91 to form an extension portion, on which at least one limiting through hole 95 is provided, and a corresponding limiting hole 41 is provided on the power supply 4. A locking piece 93 passes through the limiting through hole 95 and is screwed together with the limiting hole 41 to achieve limiting, thereby preventing the connection between the power supply part 4 and the hanging support component 9 from loosening or falling off due to vibration or gravity during use of the LED lamp 100.

In the traditional device, the mounting hole 13 protrudes outward, for example, it protrudes relative to the power supply 4, so as to fix the hanging support component 9. Further, it is to accommodate the threaded part 91 through the outward protruding mounting hole 13, and the arrangement of locking piece 93 is also horizontal, that is, approximately parallel to the light emitting surface of the LED lamp. Under the influence of vibration, it is easy to fall off outward and affect the integrity and reliability of the overall structure of the LED lamp.

In the present application, the components inside the power supply part 4 are arranged so that the mounting hole 13 is recessed in the power supply part 4, which can reduce the height of the LED lamp relative to the traditional convex structure; at the same time, the threaded portion 91 is provided with an extension portion, which is roughly parallel to the light-emitting surface of the LED lamp, and a limiting through hole 95 is provided to match the recessed limiting hole 41 on the power supply part 4, so that the locking piece 93 can be in a vertical state, that is, roughly perpendicular to the light-emitting surface of the LED lamp, that is, the plane where the light source part 2 is located, and the locking piece 93 and the limiting hole 41 are threadedly matched, so that most of the force generated by the vibration of the LED lamp is in the up and down or horizontal direction, rather than the force of rotation around the axis, and it is difficult to loosen or disengage the locking piece 93 and the limiting hole 41, thereby greatly improving the reliability of the LED lamp.

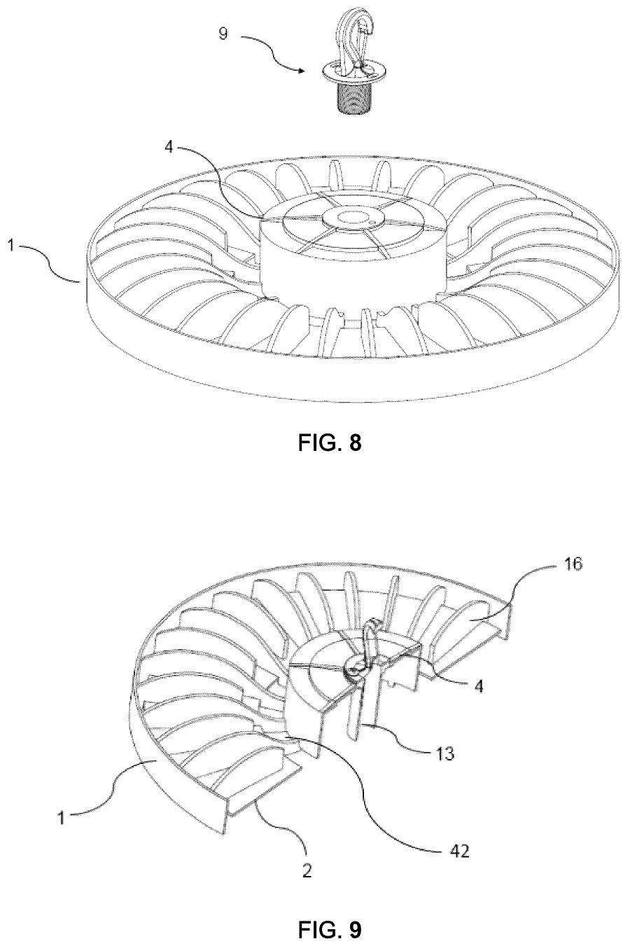

FIG. 8 is a schematic diagram of an LED lamp 100 after the hanging support component 9 is disassembled separately in one embodiment of the present invention. In one embodiment of the present invention, the power supply part 4 and the base 1 are integrally formed, and the hanging support component 9 is fixed to the power supply part 4 through a threaded structure.

In one embodiment of the present invention, the hanging support component 9 and the power supply part 4 can also be fixed by buckles.

In some embodiments of the present invention, the power supply part 4 and the base 1 are separate structures, and the power supply part 4 is fixed by welding, snapping, gluing, screws, etc.

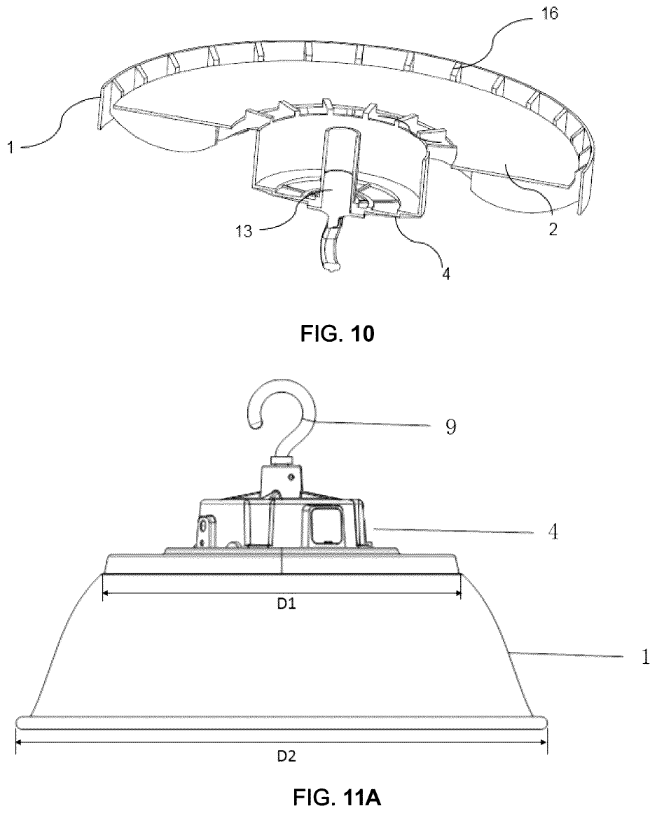

Refer to FIGS. 9 and 10, which are schematic cross-sectional diagrams along the radial direction of the base 1 from two viewing angles of the front and back sides of the LED lamp in an embodiment of the present application. As shown in the figure, the light source part 2 is a hollow annular plate, and a snap-fit portion is provided on the heat dissipation part 16 for snapping the light source part 2, and the heat dissipation part 16 is perpendicular to the surface of the light source part 2. The heat generated by the light source part 2 when working is guided and dissipated through the heat dissipation part 16, and the heat dissipation part 16 is perpendicular to the surface of the light source part 2. The heat dissipated by the light source part 2 will not be blocked or hindered by the surface of the heat dissipation part 16, thereby improving the heat dissipation effect of the LED lamp. In other words, the light source part 2 is composed of a light source board and a plurality of LED light beads (LED light-emitting bodies) arranged on the light source board (not shown in the figure), and the heat dissipation part 16 is composed of a plurality of heat dissipation fins, and the surface of the heat dissipation fins is perpendicular to the surface of the light source board, that is, the surface of the heat dissipation fins is along the vertical direction or parallel to the vertical direction, that is, parallel to the optical axis of the LED lamp.

The light source part 2 is hollow and the power supply part 4 is completely exposed. The power supply part 4 is connected and fixed to the heat dissipation part 16, and the heat dissipation part 16 are spaced from each other. A heat dissipation channel 42 (see FIG. 5) that runs through the light source part 2 and the power supply part 4 is formed, that is, it extends along the optical axis direction of the LED lamp. The heat dissipation part 16 is parallel to the heat dissipation channel 42, that is, the heat dissipation fins of the heat dissipation part 16 are parallel to the extension direction of the heat dissipation channel 42, and can quickly take away the heat generated by the LED lamp through air convection.

In the light emitting direction of the LED lamp, the projections of the heat dissipation part 16 and the power supply part 4 do not overlap or the overlapping area is zero, and the heat dissipation part 16 surrounds the power supply part 4, but they are not in direct contact with each other, that is, they are spaced from each other. Similarly, the positional relationship between the light source part 2 and the power supply part 4 is the same as the positional relationship between the heat dissipation part 16 and the power supply part 4.

In one embodiment of the present invention, hollow holes are provided to form air channels inside and outside the LED lamp, so that air convection is achieved inside and outside the LED lamp to quickly cool down the lamp.

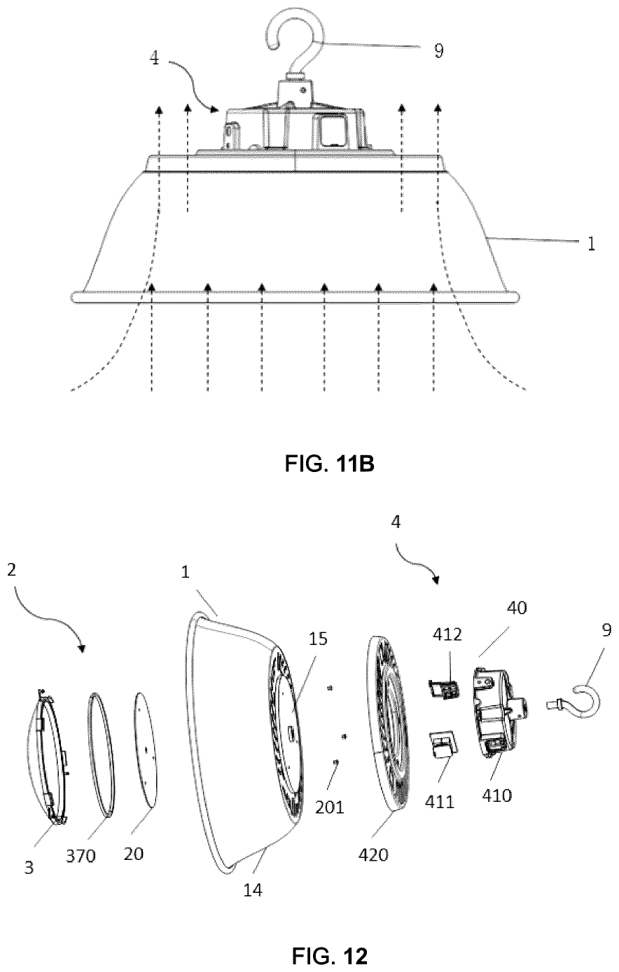

Referring to FIGS. 11A to 18, the LED lamp of the present application includes: a base 1, a light source unit 2, a power supply unit 4 and a hanging support assembly 9.

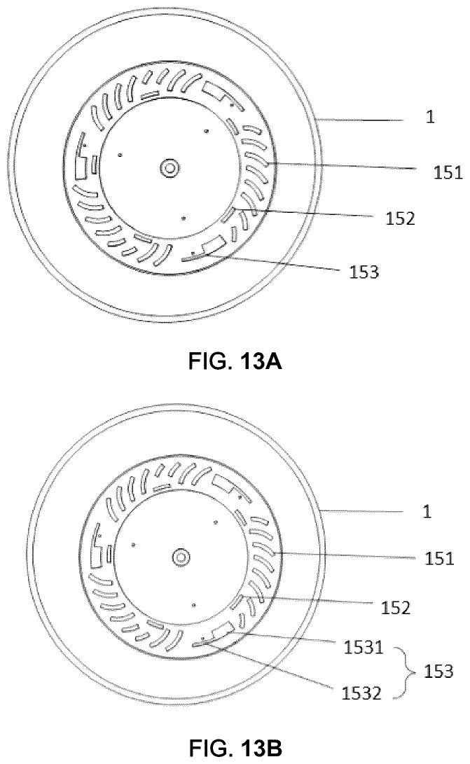

Referring to FIGS. 12 to 13B, the base 1 has a bottom plate 15 and a side wall 14. The bottom plate 15 and the side wall 14 of the base 1 form an accommodating space. The light source part 2 is accommodated in the accommodating space. The bottom plate 15 of the base 1 is preferably a flat bottom plate, and the light source part 2 is fixed to the bottom plate 15 in a relatively parallel state. More specifically, the light source part 2 is fixed to one surface of the bottom plate 15 in a relatively parallel state in the accommodating space formed by the bottom plate 15 and the side wall 14. In other embodiments of this invention, the bottom plate 15 of the base 1 can include a first hollow hole 151 that communicates the inside and outside of the accommodating space. The first hollow hole 151 is used for gas flow. The gas can be air. Air can flow from the accommodating space to the outside of the accommodating space through the first hollow hole 151, or from the outside of the accommodating space to the accommodating space through the first hollow hole 151. The heating elements of the LED lamp during operation are generally LED light beads and the power supply, that is, part of the light source part 2 and the power supply part 4 in this article.

In this invention, the base 1 is in a trumpet shape. That is, the diameter of the base 1 has a certain difference (change) along the axial direction, so that the base 1 gradually change regularly or irregularly along the axial direction, forming a shape with one end being large and one end being small. In this embodiment, the base 1 has a smaller diameter at the end where the bottom plate 15 is located and a larger diameter at the end away from the bottom plate. That is, the diameter of the base 1 at the end where the bottom plate 15 is located is smaller than the diameter of the end away from the bottom plate 15. In other words, the base 1 is composed of a bottom plate 15 and a side wall 14 surrounding the bottom plate 15, wherein the side wall 14 is disposed on the same side of the bottom plate 15 and extends in the same direction. In one embodiment of this application, the bottom plate 15 is circular or nearly circular, but it can also be of other shapes, such as an ellipse, a rectangle, or a square, etc. The side wall 14 surrounds the bottom plate 15 to form a frustum-like structure. The diameter of the side wall 14 at the end close to the bottom plate 15 is less than or equal to the diameter of the side wall 14 at the end away from the bottom plate 15 (see FIG. 11A). That is, the side wall 14 has a first diameter D1 at the end close to the bottom plate 15 and has a second diameter D2 at the end away from the bottom plate. The first diameter D1 is less than or equal to the second diameter D2, which is the diameter along the direction perpendicular to the optical axis of the LED lamp. That is, in the base 1, a first diameter D1 is formed at the end where the side wall 14 is connected to the bottom plate 15, and a second diameter is formed at the opposite end of the side wall 14 away from the connection with the bottom plate 15, and the first diameter is less than or equal to the second diameter. It can also be said that along the light emitting direction of the LED lamp, the radius of the LED lamp gradually increases along its light emitting direction. The light source part 2 and the power supply part 4, which are components that generate heat during operation, are arranged near the bottom plate 15, that is, at the end with a smaller diameter. The light source part 2 is disposed on the side of the bottom plate 15 facing the side wall 14, and the power supply part 4 is disposed on the side of the bottom plate 15 facing away from the side wall 14, that is, on different sides of the bottom plate 15, so as to reduce the mutual influence of the heat generation of the light source component 20 and the power supply part 4. The end with a larger diameter of the base 1 is in an open and uncovered state. Heating components will increase the temperature of the surrounding areas, including components in direct and indirect contact with them, as well as the air. When there is a relative temperature difference in the air, the air will produce relative flow, such as the relative flow of cold air and hot air. In this embodiment, the heat-generating components, namely the light source part 2 and the power supply part 4, are arranged on the bottom plate 15, that is, at the position with a smaller diameter of the LED lamp, so that the relative temperature of the air at the position with smaller diameter is higher, while the relative temperature of the air in the area with larger diameter of the LED lamp and the position of the base away from the bottom plate 15 is lower. Further, when the LED lamp is in operation, the horizontal height of the end with a smaller diameter is greater than the horizontal height of the end with a larger diameter. The end having higher temperature is the end with a smaller diameter where the bottom plate 15 is located, and the air temperature near this end is higher, causing hot air to rise and move out of the lamp through the first hollow hole 151. When the air near the bottom plate 15 (the end with a smaller diameter) moves outside the lamp, a local pressure difference is formed between the end with a smaller diameter and the end with a larger diameter. That is, the air pressure near the end with a smaller diameter is lower than the air pressure near the end with a larger diameter, and the air at the end with a larger diameter moves towards the air at the end with a smaller diameter. Furthermore, the gas flow rate can be roughly expressed as flow rate=V/(T×S), where T represents time, V represents the gas volume, and S represents the cross-sectional area of the pipeline. According to the volume V of the air discharged within the compression air time T and the cross-sectional area S of the pipeline, the flow rate in the pipeline can be calculated, that is, the movement speed in the base 1 (which can be approximately regarded as a pipeline). When other conditions remain unchanged and the diameter of the pipeline becomes smaller, that is, S becomes smaller, the flow rate increases. The movement of air from the end with a larger diameter of the base 1 to the end with a smaller diameter is a gradually accelerating process. During operation, relatively cold air continuously flows in from the end with a larger diameter of the base 1 and flows out from the end with a smaller diameter, quickly taking away the heat of the light source part 2 and the power supply part 4. And no additional active heat dissipation components (such as fans and other structures) are required to realize directional airflow delivery, realizing passive airflow drive. Further, it can be said that the byproduct of the lamp working, the unwanted heat, is used as a driving source to drive the airflow, realizing waste energy utilization and optimizing the heat dissipation effect, as shown in FIG. 11B. The flowing gas allows the interior of the accommodation space to exchange heat with the external environment quickly, taking away the heat emitted by the light source part 2 accommodated in the accommodation space of the base 1 at a faster speed, effectively reducing the temperature of the LED lamp and prolonging the life of the LED lamp. The base 1 serves as the lamp body part of a traditional high-power LED lamp, and heat is dissipated by hollow holes arranged on the base 1. Compared with the conventional heat dissipation through heat sinks, the structure is simplified, and the production cost and process difficulty are reduced. The base 1 can be arranged in a trumpet shape, the diameter of the bottom plate 15 of the base 1 is smaller than the diameter of the opening of the base 1. A reflective layer can also be arranged inside the side wall 14 of the base 1, and the base 1 can protect the light source part 2. At the same time, the reflective layer on the inner wall of the base 1 can improve the light emission rate and the luminous brightness of the light source 2. The reflective layer on the inner wall of the base 1 can be formed by the material properties of the base 1 itself, or by an additional coating or film-sticking processes, or by additionally setting other materials (such as additionally setting a smooth metal sheet attached to the side wall 14). As a preferred embodiment, the base 1 is made of metal. Metal has good thermal conductivity. Materials with good thermal conductivity tend to absorb heat quickly and dissipate heat quickly. The metal base 1 can quickly transfer the heat of the light source part 2 and dissipate it quickly, which can quickly reduce the temperature of the light source part 2 and increase the life of the LED lamp. The base 1 can be made of silver, copper, aluminum, tungsten, magnesium, and other materials. In this embodiment, the base 1 is made of aluminum material. Aluminum has good thermal conductivity. At the same time, the density of aluminum is low, which can reduce the weight of the base 1, and the price of aluminum is relatively low, reducing the production cost.

The light source part 2 is disposed in the accommodating space of the base 1, and the light source part 2 is used for lighting.

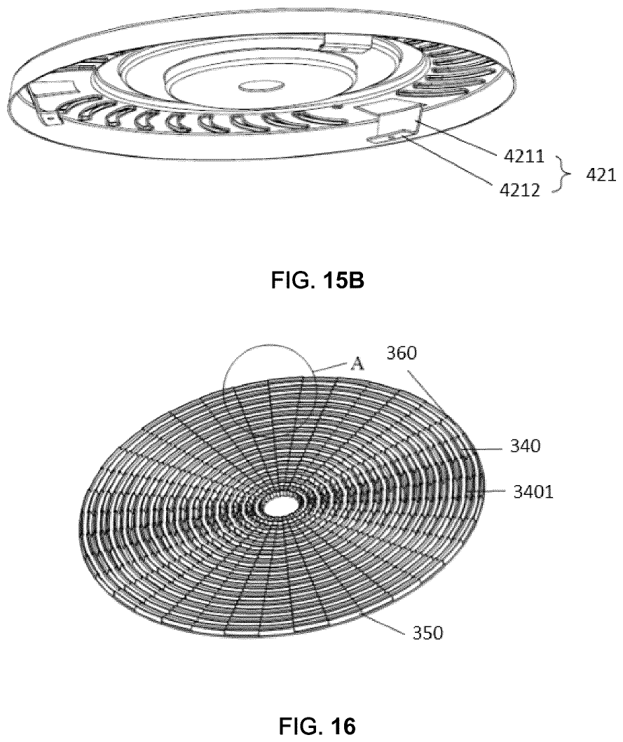

The power supply part 4 is disposed on the side of the bottom plate 15 of the base 1 away from the light source part 2 (or on the other side opposite to the light source part 2) and is electrically connected to the light source part 2. The power supply part 4 supplies power to the light source part 2. As a preferred embodiment, the power supply part 4 is detachably connected to the bottom plate 15 of the base 1, so that the power supply unit 4 can be quickly installed on the bottom plate 15 of the base 1 or the power supply unit 4 can be quickly removed from the base 1, thereby improving the assembly efficiency and facilitating the installation and maintenance of the LED lamp. At the same time, when a certain component of the lamp is damaged, it is only necessary to remove and replace the certain component as needed without replacing the entire lamp, thereby realizing modular assembly and replacement among lamp components and reducing subsequent maintenance costs. (Combined with FIG. 15A), the power supply part 4 is fixed to the base 1 through a cover plate 420 in the power supply part 4. A clamp 421 is disposed on the cover plate 420, and the bottom plate 15 of the base 1 can include a second slot 153. The clamp 421 on the cover plate 420 and the second slot 153 on the bottom plate 15 cooperate with each other to fix the power supply part 4 and the base 1. It is worth mentioning that the second slot 153 includes an insertion portion 1531 and a fastening portion 1532. The width of the insertion portion 1531 in the radial direction of the base 1 is much larger than the width of the fastening portion 1532 in the radial direction. The clamp 421 can include a bent structure, and this bent structure can be in an L-shape. Referring to FIG. 15B, the clamp 421 is L-shape and includes an extension portion 4211 and a bending portion 4212, wherein the bending portion 4212 is substantially parallel to the bottom plate 15 of the base 1. The projection of the bending portion 4212 along the vertical direction of the bottom plate 15 of the base 1 can be completely accommodated in the insertion portion 1531. Or in other words, the outer peripheral contour of the bending portion 4212 is slightly smaller than the contour of the insertion portion 1531, so that the bending portion 4212 and pass through the insertion portion 1531. The thickness of the extension portion 4211 is slightly less than or equal to the width of the fastening portion 1532 in the radial direction. During the fixing process of the power supply part 4 and the base 1, the bending portion 4212 is first passed through the insertion portion 1531, and the bending portion 4212 completely passes through the bottom plate 15 in the direction perpendicular to the bottom plate 15, and there is no interference between the two during the rotation process. Then rotate the power supply part 4 and the cover plate 420 so that the extension portion 4211 is engaged with the fastening portion 1532, thereby realizing quick fixing of the power supply part 4 and the base 1, that is, align the clamp 421 with the second slot 153, press down and then rotate a certain angle to complete the fixing of the power supply part 4 and the base 1.

In one embodiment, the thickness of the extension portion 4211 varies from small to large. The thickness of the extension portion 4211 on the side close to the fastening portion 1532 is smaller than the thickness of the fastening portion 1532 in the radial direction. On the side of the extension portion 4211 away from the fastening portion 1532, its thickness gradually increases and finally is slightly larger than or equal to the thickness of the extension portion 4211, enabling the extension portion 4211 to quickly enter the fastening portion 1532 and finally achieve clamping and fixing, such as an interference fit.

In one embodiment, the curvature of the extension portion 4211 is slightly smaller than the curvature of the fastening portion 1532 so that when the extension portion 4211 is going into the fastening portion 1532, the extension portion 4211 is slightly deformed, and the extension portion 4211 and the fastening portion 1532 are pressed against and compressed against each other to be fixed more firmly.

In one embodiment, the extension portion 4211 is inclined, that is, relative to the bottom plate 15, the straight-line distance between the bending portion 4212 and the center of the bottom plate 15 is smaller than the straight-line distance between the junction of the extension portion 4211 and the cover plate 420 and the center of the bottom plate 15. Furthermore, clamp 421 has a certain elasticity and can be slightly deformed to a certain extent. The outer peripheral radius of the bottom of the clamp 421, that is, the bending portion 4212, is slightly smaller than or equal to the outer contour radius of the insertion portion 1311, and the radius of the circumference of the arc of the extension portion 4211 gradually increases from the bending portion 4212 to the cover plate 420. When the power supply part 4 and the base 1 are fixed, the power supply part 4 is slightly pressed downward, that is, the clamp 421 passes through the insertion portion 1531. The clamp 421 passes through the insertion portion 1531 through a certain pressure, and its extension portion 4211 is abuts against the outer periphery of the insertion portion 1531. As the radius of the extension portion 4211 gradually increases, it is forced to deform toward the center of the bottom plate 15 (of course it can also be the center, and the bottom plate 15 can also be other shapes, such as a rectangle, etc.), and has a tendency to move away from the center of the bottom plate 15, applying a pressure to the outer periphery of the insertion portion 1531. When the extension portion 4211 goes into the fastening portion 1532, on the one hand, the thickness of the extension portion 42111 is greater than the fastening portion 1532, and the clamp 421 cannot escape. On the other hand, the extension portion 4211 is deformed and abuts against the fastening portion 1532, and the clamp 421 is difficult to slide relative to the fastening portion 1532, thereby avoiding abnormal noise or loosening and improving the fixing effect.

In one embodiment, the extending portion 4211 has a groove corresponding to the fastening portion 1532, and the extending portion 4211 and the fastening portion 1532 can be partially embedded.

In one embodiment, a magnetic element is disposed on the bending portion 4212, and a magnetic element is also disposed near the fastening portion 1532, and the two attract each other to achieve better fixation.

When the power supply part 4 and the base 1 are to be disassembled, the disassembly is completed by rotating them in the reverse direction or by applying a certain pressure and then rotating them in the reverse direction, and completely withdrawing the clamp 421 from the insertion portion 1531.

The volume of the accommodating space of the base 1 is larger than the volume of the power supply part 4. When packaging, the light source part 2 and the power supply part 4 can be placed together in the accommodating space of the base 1. Only one packaging box is required. There is no need to package the various parts of the LED lamp separately, which saves packaging costs and improves packaging and transportation efficiency. During installation, the light source part 2 is arranged in the accommodating space of the base 1, and the power supply part 4 is arranged on the side of the bottom plate 15 of the base 1 away from the light source part 2. The power supply part 4 is arranged outside the base 1 and has a certain interval from the light source part 2, avoiding the mutual influence of the heat generation of the power supply part 4 and the light source part 2 from intensifying, which is beneficial to the heat dissipation of the power supply part 4. Furthermore, the power supply part 4 is surrounded by the first hollow hole and is in the air outlet direction to accelerate the heat dissipation of the power supply part 4.

In a specific embodiment, the light source part 2 includes a light board 20 and a lampshade 3. Light beads (that is, LED light emitting bodies 211, not shown) are disposed on the light board 20. The light beads are used for lighting and are evenly distributed along the light board 20. The light beads can be LED light beads. The lampshade 3 is disposed in front of the light emitting direction of the light beads and completely covers the light beads (on the LED light emitting bodies 211), that is, completely covers the light beads (LED light emitting bodies 211). The lampshade 3 can be made of light-transmitting materials, such as glass, resin, acrylic, plastic, etc. The lampshade 3 can be fixed to the light board 20 or the base 1 and completely cover the light board 20. Furthermore, in the direction perpendicular to the light board 20, the projection of the lampshade 3 can completely cover the light board 20, thereby forming a relatively sealed environment, effectively protecting the light board 20 and the relevant components fixed on the light board 20.

The lampshade 3 can be a PC cover or a lens. On the one hand, the lampshade 3 can protect the light beads from damage, and on the other hand, it can adjust the light emitting angle of the light emitted by the light beads, thereby enhance the utilization efficiency of the light emitted by the light beads and the luminous efficiency of the light beads. In one embodiment of this invention, the lampshade 3 can be a lens that protrudes relative to the light board 20 toward the light emitting direction of the LED lamp. This lens has a curved surface with a certain radian, and the side facing the light board 20 is a concave cavity, so that the light board 20 and at least one electronic component can be accommodated in the concave cavity. At the same time, the lampshade 3 is a convex lens that protrudes along the light emitting direction of the LED light beads, which has a light diffusion and homogenization effect relative to the light emitting of the LED lamp beads (i.e., LED light-emitting body), thereby expanding the light emitting angle of the lamp and reducing glare. In addition, compared with traditional LED lamps, the lamp has the above structured without the face ring. In traditional lamps, the light board lens needs to be fixed by a face ring. The outer diameter of the face ring is slightly larger than the outer diameter of the lens, and the inner diameter is slightly smaller than the outer diameter of the lens. The face ring is generally fastened to the bottom plate 15 by screws. A part of the ring structure of the face ring will fit a part of the lens close to the outer diameter, pressing the lens on the light board 20, fixing the lens to the light board 20, and further strengthening the fixation of the light board 20. The lampshade 3 (or the lens) itself has a fixing structure, so the structure of the face ring fixing the lens can be eliminated, which greatly simplifies the structure of the lamp, improves assembly efficiency, and reduces production costs.

The power supply part 4 includes a power supply module 40. The power supply module 40 is disposed on a side of the bottom plate 15 of the base 1 away from the light source part 2. The power supply module 40 is electrically connected to the light source part 2. The power supply part 4 also includes a cover plate 420, on which the power supply module 40 is disposed. The cover plate 420 is disposed on a side of the bottom plate 15 of the base 1 away from the light source part 2. The cover plate 420 is provided with a second hollow hole 423. The second hollow hole 423 corresponds to the first hollow hole 151 and is used for gas flow. The gas can be air. Air can pass through the first hollow hole 151 and the second hollow hole 423. After the air flows, it takes away heat, effectively reducing the temperature of the LED lamp, avoiding the impact of high temperature on the electronic components and some heat-intolerant materials in the lamp, and improving the service life of the LED lamp. That is, the ring belt where the first hollow hole 151 and the second hollow hole 423 are located forms the heat dissipation part of the LED lamp. In the light emitting direction of the LED lamp, the projection of this heat dissipation part is spaced apart from the power supply part, and this heat dissipation part surrounds the power supply part.

In a specific embodiment, the light board 20 is connected to the bottom plate 15 of the base 1 by a fastener 201. The bottom plate 15 of the base 1 is provided with a through hole for the fastener 201 to pass through. A first sealing ring 202 is provided at the through hole and is sleeved on the fastener 201. The first sealing ring 202 can be a rubber ring. The light board 20 and the bottom plate 15 of the base 1 are closely connected together through the fastener 201. The light board 20 is basically attached to the bottom plate 15, so that the heat of the light source part 2 is quickly conducted to the base 1 and then quickly dissipated after the heat is taken away by gas flow, thereby accelerating the cooling speed of the LED lamp and further improving the service life of the LED lamp. The first sealing ring 202 sleeved on the fastener 201 can improve the sealing performance between the fastener 201 and the through hole, thereby preventing external water vapor from seeping through the through hole to affect the service life of the light beads or cause a short circuit of the electronic components on the light board 20. Referring to FIG. 18, the first sealing ring 202 preferably adopts a rivet structure, which can further improve the sealing performance between the fastener 201 and the through hole, achieving the waterproof sealing of the LED lamp, such as reaching the IP66 level waterproofing, which is suitable for humid environments. The fastener 201 can be a screw or a bolt, etc. The number of fasteners 201 can be multiple. In this embodiment, the number of fasteners 201 is three.

In another specific embodiment, an adhesive (not shown) is provided between the light board 20 and the bottom plate 15 of the base 1. The light board 20 is bonded to the bottom plate 15 of the base 1 by the adhesive. The adhesive is preferably a thermally conductive adhesive. The thermally conductive adhesive has good thermal conductivity and can quickly transfer the heat of the light source part 2 to the base 1 and then quickly dissipate it after the heat is taken away by gas flow, thereby accelerating the cooling speed of the LED lamp and further improving the service life of the LED lamp. The thermally conductive adhesive can be a composite colloid with a certain amount of thermal conductive particles mixed in the adhesive material.

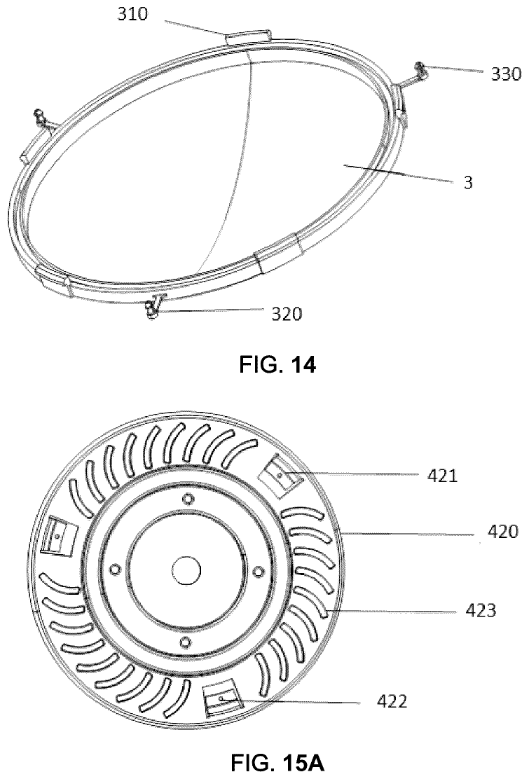

As a preferred embodiment, a part of the structure of the cover plate 420 passes through the bottom plate 15 and is located in the accommodating space of the base 1. The lampshade 3 is detachably connected to the bottom plate 15. Specifically, referring to FIG. 13A, the bottom plate 15 of the base 1 has a first card slot 152 and a second card slot 153. Referring to FIG. 14, the lampshade 3 is provided with a snap-fit cantilever 310. The snap-fit cantilever 310 of the lampshade 3 is locked in the first card slot 152 to connect the lampshade 3 to the base 1. Through the snap-fit cantilever 310 and the first card slot 152, the lampshade 3 and the base 1 can be quickly installed and disassembled for easy operation. Referring to FIG. 15A, the cover plate 420 is provided with a clamp 421. The clamp 421 is locked in the second card slot 153 to connect the cover plate 420 to the base 1. Through the structure of the clamp 421 and the second card slot 153, the cover plate 420 and the base 1 can be quickly installed and disassembled for easy operation. As a preferred embodiment, the light source part 2 also includes a second sealing ring 370. The second sealing ring 370 is located between the lampshade 3 and the bottom plate 15 of the base 1. The second sealing ring 370 can make the lampshade 3 and the bottom plate 15 of the base 1 form a sealed space, preventing external water vapor from entering, thereby better protecting the LED light beads and improving the service life and reliability of the LED lamp.

Referring to FIG. 14, the lampshade 3 is also provided with a positioning post 320. The bottom plate 15 of the base 1 and the cover plate 420 are provided with corresponding positioning holes 422. The positioning holes 422 are used for the positioning post 320 to pass through to fix the lampshade 3 and the cover plate 420 on the base 1. Specifically, the positioning post 320 can be arranged around the lampshade 3 or connected to the lampshade 3 through a connecting part. The connecting part can be made of a deformable material or a non-deformable material. The connecting part is preferably made of a deformable material. As a preferred embodiment, the positioning post 320 is an elastic body, and the free end of the positioning post 320 has a stop portion 330. When the positioning post 320 passes through the positioning hole 422, the stop portion 330 of the positioning post 320 first shrinks and then expands so that the stop portion 330 is stuck at the positioning hole 422. The lampshade 3 and the cover plate 420 can be further fixed to the base 1 through the interaction between the positioning post 320 and the positioning hole 422.

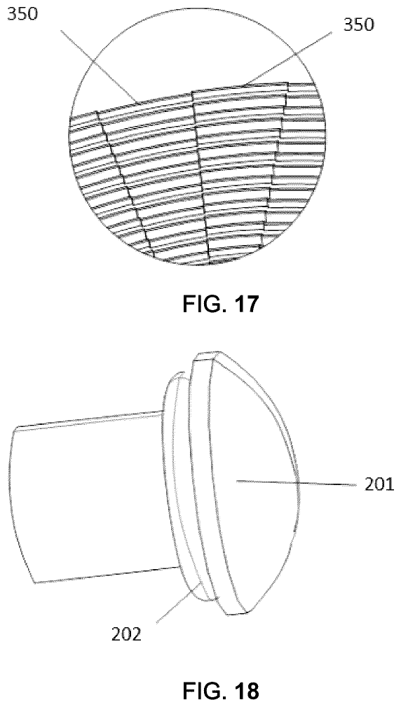

In an embodiment, the lampshade 3 has an incident surface and an exit surface. The lampshade 3 acts as an adjustment part to adjust the light output. Referring to FIGS. 16 and 17, a plurality of annular protrusions 340 are provided on the incident surface and/or the exit surface, and the plurality of annular protrusions 340 are distributed at intervals along the radial direction of the lampshade 3. Each annular protrusion 340 includes a plurality of protruding sections 3401, and the adjacent two protruding sections 3401 of each annular protrusion 340 are staggered in the radial direction of the lampshade 3. In other words, the distances between two protruding sections 3401 adjacent to each annular protrusion 340 and the center of the lampshade 3 are different, wherein the even-numbered protruding sections 3401 of each annular protrusion 340 can be located on the same arc, and the odd-numbered protruding sections 3401 of each annular protrusion 340 can be located on the same arc. Rotating the lampshade 3 changes the position between the annular protrusion 340 and the light beads (i.e., the LED light-emitting body), so that the light emitting angle of the light emitted from the lampshade 3 by the light beads changes, thereby changing the light emitting effect of the LED lamp, such as a spotlight effect or a light diffusion effect, to meet the use in different application scenarios. A plurality of protruding sections 3401 of the annular protrusion 340 are provided with light effect surfaces along the circumferential direction of the lampshade 3. As shown in FIG. 16, the light effect surface 350 and the light effect surface 360 corresponding to the light effect surface 350, where the light effect surface 350 and the light effect surface 360 form a certain angle with the horizontal plane (the horizontal plane where the LED light beads are located). In some embodiments, the angle between the light effect surface 350 and the light effect surface 360 and the horizontal plane is controlled between 10° and 150°, so that the light emitted by the LED light beads can undergo specific light conversion on the light effect surface 350 and the light effect surface 360, such as reflection, refraction, scattering, light convergence, etc.

If the lampshade 3 is rotated by a certain angle, the distance and angle between the light effect surface 350 and the light effect surface 360 will change. After reflection and refraction, the overall light output angle of the lamp changes. For example, the light output angle may range from 30° to 120°, 45° to 90°, etc.

In some embodiments, a pointer can be disposed on the lampshade 3, and a corresponding light output angle can be shown on the lamp board 20. That is, after the pointer on the lampshade 3 rotates to the corresponding light output angle, the light output angle of the lamp is adjusted to the light output angle corresponding to this angle, which is convenient for operation.

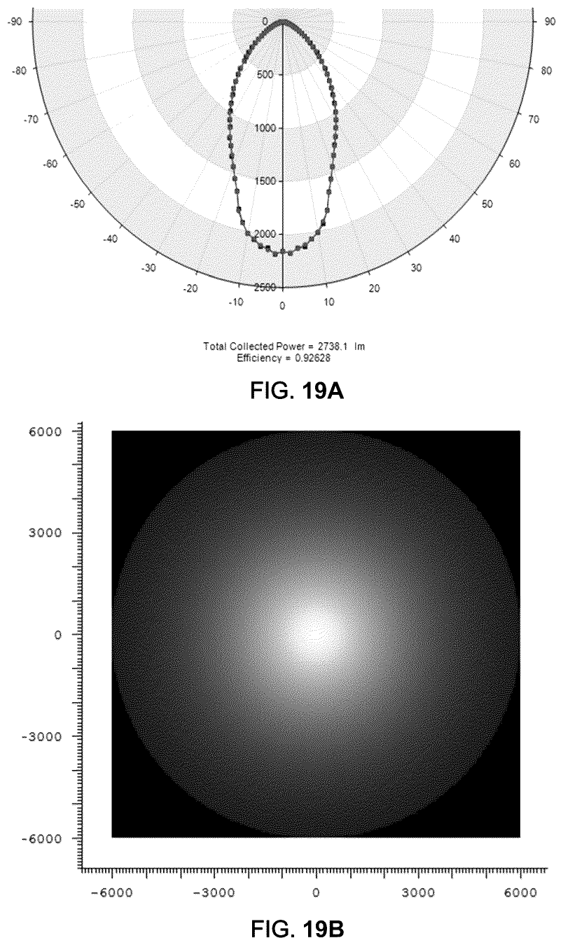

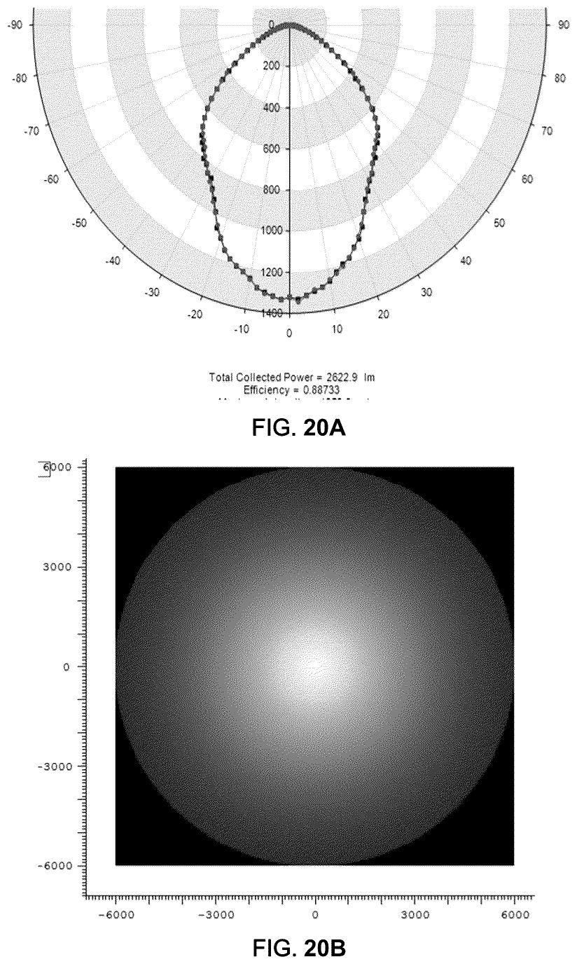

In some embodiments, when the LED light beads are at the middle position of the gap between the corresponding protruding sections 3401 in the annular protrusion 340, the light output angle of the lamp is the smallest; when the LED light beads are close to the corresponding protruding sections 3401 of the annular protrusion 340, the light output angle of the lamp is the largest. FIGS. 19A-20B are schematic diagrams of the light pattern and light efficiency in some embodiments of this invention under certain conditions, the maximum light output angle is set to 90° and the minimum light output angle is 45°. FIG. 19A is the light pattern diagram under the condition of 45° light output angle, and FIG. 19B is the light efficiency diagram under the condition of 45° light output angle. Under this condition, the light is concentrated to the central area of the lamp, and there is a higher illumination directly below or in the central area, which is suitable for use in scenarios where require higher illumination and can clearly see things, such as picking goods and observing colors. FIG. 20A is the light pattern diagram under the condition of 90° light output angle, and FIG. 19B is the light efficiency diagram under the condition of 90° light output angle. Under this condition, the light is divergent and has a wider illumination range, which is suitable for wide environments where do not require too high illumination, such as some wide transportation roads.

In some embodiments, the positioning post 320 and the stop portion 330 can also be eliminated to increase the adjustment range of the lampshade 3.

In a specific embodiment, referring to FIG. 12, the power supply module 40 includes a housing 410, a driving power supply (not shown), and an adjustment switch 411. The housing 410 has a chamber for accommodating the driving power supply, and the driving power supply is electrically connected to the light board 20. The adjustment switch 411 is connected to the driving power supply and partially exposed from the housing 410. The adjustment switch 411 is used to control the driving power supply. The adjustment switch 411 can be set to adjust the color temperature and power. The color temperature adjustment can have multiple levels, and the power adjustment can also have multiple levels. There are three levels of color temperature adjustment, for example: CW (cool white), NW (warm white), and WW (neutral white). Among them, the color temperature of NW (warm white) is about 3000k, the color temperature of WW (neutral white) is about 4000k, and the color temperature of CW (cool white) is generally above 5000k. There are three levels of power adjustment, for example: 150 W, 200 W, and 250 W, but it is not limited to these three levels of power and can be adjusted according to actual needs. In this way, the LED lamp can have nine different modes of brightness and color temperature to meet the needs of different applications. The power supply module 40 also includes an auxiliary power supply (not shown) and a wireless control device 412, wherein the auxiliary power supply can adjust the external environment access power supply (such as main power), such as adjusting the current and voltage, so that the auxiliary power supply can supply power to different types of wireless control device 412. The auxiliary power supply supplies power to wireless control device 412, and the wireless control device 412 is used to control the driving power supply. The wireless control device 412 can be connected to an intelligent module, such as Bluetooth, etc., to achieve intelligent control, facilitating switching of different working modes of the LED lamp or remote lighting, etc., so that the LED lamp has the function connecting to Internet.

To facilitate the installation of the LED lamp in the external environment, referring to FIG. 11A, the LED lamp further include a hook 9. One end of the hook 9 is connected to the power supply part 4. The hook 9 can be connected to the power supply part 4 by means of threaded connection, which is convenient for installation and disassembly.

In some embodiments, the auxiliary power supply also has a certain power storage function, enabling the lamp to be used for a period of time when there is a power outage. For example, when there is a power outage, it can be lit in a low power mode for a long time to serve as an emergency power supply.

In this invention, the above features can be arranged and combined in any way and used to improve LED lamp.

It should be understood that the above description is for illustrative purposes rather than for limitation. After reading the above description, many embodiments and many applications other than the provided examples will be obvious to those skilled in the art. Therefore, the scope of this teaching should not be determined by referring to the above description, but should be determined by referring to the claims and the full scope of equivalents of these claims. For the sake of comprehensiveness, all articles and references, including patent applications and announcements, are incorporated herein by reference. Omitting any aspect of the subject matter disclosed herein in the foregoing claims is not intended to abandon that subject matter, nor should it be considered that the inventor did not consider that subject matter as part of the disclosed inventive subject matter.

1-22. (canceled)

23. An LED lamp, comprising:
a light source part, comprising a light source board and a plurality of LED beads arranged on the light source board, wherein the light source board is an annular plate and is disposed on a first side of the light source part;
a heat dissipation part connected on a second side of the light source part, the heat dissipation part comprising a plurality of heat dissipation fins be in radial distribution and perpendicular to the light source board;
a power supply part disposed at a center of the light source board and connected to the heat dissipation part; and
a heat dissipation channel arranged between the power supply part and the light source part, wherein the heat dissipation fins of the heat dissipation part are parallel to the heat dissipation channel,
wherein the projections of the light source part and the heat dissipation part in a light emitting direction of the LED lamp are spaced apart from the power supply part and surround the power supply part.

24. The LED lamp according to claim 23, wherein the plurality of heat dissipation fins point to the center of the light source board and at least one heat dissipation fin connects to the power supply part.

25. The LED lamp according to claim 24, wherein the heat dissipation channel is parallel to an optical axis direction of the LED lamp and the surfaces of the plurality of heat dissipation fins.

26. The LED lamp according to claim 25, wherein at least a portion of one of the heat dissipation fin is disposed in the heat dissipation channel and connected to the power supply part.

27. The LED lamp according to claim 26, wherein power supply part includes a housing connected to the heat dissipation part, a power supply module disposed in the housing and electrically connected to the light source board.

28. The LED lamp according to claim 27, wherein the power supply module includes an adjustment switch exposed from the housing.

29. The LED lamp according to claim 28, wherein the power supply module further includes an auxiliary power supply capable of regulating input power of the LED lamp.

30. The LED lamp according to claim 29, wherein the power supply module further includes a wireless control device electrically connected to the auxiliary power supply.

31. The LED lamp according to claim 30, wherein the power supply part includes a mounting hole recessed in the power supply part.

32. The LED lamp according to claim 31, wherein the LED lamp further comprises a hanging support component including a threaded portion matched and fixed with the mounting hole of the power supply part.

33. The LED lamp according to claim 32, wherein the threaded portion includes an extension portion extending radially outward from the threaded portion, and a limit through hole is disposed on the extension portion.

34. The LED lamp according to claim 33, wherein the power supply part includes a limiting hole corresponding to the limit through hole and a locking piece passes through the limit through hole and the limit hole.

35. The LED lamp according to claim 34, wherein the locking piece is installed in the limit through hole and perpendicular to a light emitting surface of the LED lamp.

36. The LED lamp according to claim 35, wherein the threaded portion is disposed at one end of the hanging support component, and a hanging portion and a movable closure cooperating with the hanging portion are disposed at the other end of the hanging support component.

37. The LED lamp according to claim 36, wherein the movable closure is capable of being opened or closed relative to the hanging portion to form a closed loop structure or an open loop structure.
